(19) United States
(12) Patent Application Publication
(10) Pub. No.: US 2012/0099396 A1
(43) Pub. Date: Apr. 26, 2012

(54) SYSTEM AND METHOD FOR CHARACTERIZATION WITH NON-UNIQUE SOLUTIONS OF ANISOTROPIC VELOCITIES

(75) Inventors: Cory J. Hoelting, Houston, TX (US); Jennifer L. Lewis, Houston, TX (US); James M. Davenport, Houston, TX (US)

(73) Assignee: Chevron U.S.A. Inc.

(21) Appl. No.: 12/910,042

(22) Filed: Oct. 22, 2010

(51) Int. Cl. G01V 1/28

(52) U.S. Cl. 367/73

(57) ABSTRACT

A system and method for characterizing structural uncertainty in a seismic analysis of features in a subsurface region includes obtaining seismic data including information representative of the features, performing a plurality of depth migrations on the seismic data, each depth migration being based on a model using a respective set of parameters relating to a velocity field and anisotropy of the subsurface region, selecting a family of equivalent solutions from the plurality of depth migrations, evaluating a characteristic of at least a portion of the subsurface region for each member of the family of equivalent solutions, determining a range of values of the evaluated parameters, and based on the determined range, determining a degree of uncertainty of the seismic analysis.

### FIELD OF THE INVENTION

The present invention relates generally to methods and systems for subsurface characterization and more particularly to such methods and systems that take into account non-unique solutions of anisotropic velocities.

### BACKGROUND OF THE INVENTION

Oil and gas prospect evaluation and field development require accurate characterization of subsurface features. Seismic acquisition over subsurface structure generally produces time-domain data, which is then migrated to, for example, depth image data. The migration process necessarily involves certain assumptions regarding the propagation velocity of elastic waves through the subsurface materials and structures. Moreover, there is generally some degree of anisotropy in geological formations. That is, while it may be possible to determine vertical velocities using well data, the velocities estimated using multi-offset seismic techniques will necessarily be somewhat different from measured vertical velocities. Finally, because assumptions regarding both velocities and degrees of anisotropy may be incorrect, there is some inherent uncertainty in the resulting depth image.

Geophysical measurements are inherently non-unique and finite in resolution, and relate to many orders of magnitude of scale. Uncertainty in the measurements results from a variety of sources, including signal-to-noise ratio, data acquisition parameter selection, processing algorithms, or the above mentioned velocity and anisotropy parameter selection. It is therefore important to understand the degree of that uncertainty when evaluating model results. That is, it is important to quantitatively understand to what degree the models are sensitive to a given change or group of changes in the assumptions regarding velocities, anisotropy or the other factors impacting uncertainty. An understanding of the uncertainty and the range of possible characterizations allows interpreters of the data to make business decisions regarding well placement and count, development scenarios, secondary recovery strategies and other factors that ultimately impact recovery and project economics.

### SUMMARY OF THE INVENTION

According to one implementation of the present invention, a method of characterizing structural uncertainty in a seismic analysis of features in a subsurface region includes obtaining seismic data including information representative of the features, performing a plurality of depth migrations on the seismic data, each depth migration being based on a model using a respective set of parameters relating to a velocity field and anisotropy of the subsurface region, selecting a family of equivalent solutions from the plurality of depth migrations, evaluating a characteristic of at least a portion of the subsurface region for each member of the family of equivalent solutions, determining a range of values of the evaluated parameters, and based on the determined range, determining a degree of uncertainty of the seismic analysis.

According to an embodiment of the invention, a system for characterizing structural uncertainty in a seismic analysis of features in a subsurface region includes a computer readable medium having computer readable seismic data stored thereon, the seismic data being representative of physical characteristics of the subsurface region, and a processor, configured and arranged to perform a plurality of depth migrations on the seismic data, each depth migration being based on a model using a respective set of parameters relating to a velocity field and anisotropy of the subsurface region, select a family of equivalent solutions from the plurality of depth migrations, evaluate a characteristic of at least a portion of the subsurface region for each member of the family of equivalent solutions, determine a range of values of the evaluated parameters, and based on the determined range, determine a degree of uncertainty of the seismic analysis.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, pending claims and accompanying drawings where:

FIG. 1 is an illustration of the interaction between changes in vₙₘₒ and η showing a central region (semblance banana) in which substantially flat gathers are expected to be produced;

FIGS. 2a-d illustrate four different solutions for a single event, generated using different assumptions regarding vₙₘₒ and η, selected from four different points around a common semblance banana;

FIGS. 3a-c illustrate a family of three equivalent solutions produced using three different vₙₘₒ and η trends for slow, baseline and fast velocity assumptions, each of which produces a flat gather;

FIGS. 4a-c illustrate a family of three equivalent reservoir models in an exploration case based on three different vₙₘₒ and η trends for slow, baseline and fast velocity assumptions, illustrating variation in well location and target interval depths;

FIGS. 5a-c illustrate a family of three equivalent reservoir models in an appraisal case based on three different vₙₘₒ and η trends for slow, baseline and fast velocity assumptions, and constrained by ties to well data, illustrating variation in target interval depths;

FIG. 6 is a flow chart illustrating a method in accordance with an embodiment of the present invention; and

FIG. 7 is a schematic illustration of a system in accordance with an embodiment of the present invention.

### DETAILED DESCRIPTION OF THE INVENTION

The process of transforming or migrating acquired seismic data in the time domain to the depth domain uses a velocity model. Often, each volume of similar source-receiver offset traces in a seismic survey are migrated together. The volumes of different source-receiver offsets can then be re-sorted to show the continuum of source-receiver offset traces at each output location in the migrated seismic data. In evaluating the velocity model used in a migration, one factor that can be applied to verify that the resulting model is accurate is the existence of flat gathers. That is, the response due to a particular seismic reflector is indicated at the same depth across all source-receiver offsets at the same seismic trace location. It should be noted that the method described herein is not limited to offset-domain common image gathers, but may find application in subsurface angle and subsurface angle plus azimuth gathers, offset-domain plus azimuth, and other gather methods.

Because it is true that a perfect velocity model would produce flat gathers, it is generally assumed that flat gathers imply that the anisotropic velocity model is correct. However, in practice the production of flat gathers does not necessarily imply that the model is perfect, because there may be more than one velocity model that can produce flat gathers for a given set of seismic data. In other words, flat gathers are a necessary but insufficient condition for an accurate velocity model. Furthermore, for a given set of data, there are likely different velocity models that all produce flat gathers but would also yield different realizations for the subsurface structure. The resulting differences in structure may be such that a hydrocarbon reservoir appears to be larger or smaller and that the target interval for a selected well location can vary in depth. Both factors can result in improper selection of well locations and drill depths impacting the ultimate productivity and economic value of the reservoir.

The discussion above implies that the seismic data be processed with a prestack depth migration algorithm. However, those experienced in the art would realize that the seismic data could also be processed with a poststack depth migration algorithm. Although a poststack depth migration is known not to be as accurate as a prestack depth migration, certain features of this invention could be employed using an algorithm of either type. The use of a poststack depth migration algorithm in this invention precludes the analysis of migrated offset (or azimuth) versus depth gathers; however, there are other methodologies, such as image coherence, to judge the range of acceptable solutions in order to practice this invention.

To fully characterize the velocity field for a given subsurface volume of interest, the velocity data may need to be known in a variety of directions. The common terminology used includes vᵥₑᵣₜ to indicate the vertical velocity (the seismic velocity vertically in the Earth), vₙₘₒ to indicate the near offset moveout velocity of the seismic energy traveling in the Earth, η to represent a difference between the horizontal velocity of the seismic energy in the Earth and vₙₘₒ, δ to represent a difference between the vertical velocity of the seismic energy in the Earth and vₙₘₒ, and ε to represent a difference between the vertical and horizontal velocities of the seismic energy in the Earth. For a more complete explanation of the various parameters, see Thomsen (1986), and Tsvankin and Thomsen (1994). Those experienced in the art will appreciate that if the symmetry axis of the velocity in the Earth is not vertical, but rather tilted at arbitrary dip and strike angles, the velocity along the symmetry axis may be substituted for the vertical velocity in the above description. The velocity orthogonal to the symmetry axis would then be substituted for the horizontal velocity in the above description.

Depth migration of a seismic volume with an anisotropic velocity field requires at least one velocity descriptor be fully defined for the subsurface volume of interest, typically vᵥₑᵣₜ or vₙₘₒ, and two anisotropy parameters, typically η and δ, or ε and δ. Time migration of a seismic volume with an anisotropic velocity field requires only vₙₘₒ and η. Those experienced in the art will realize that using vₙₘₒ and η to assist in the velocity analysis of depth migrated data offers certain advantages. The vₙₘₒ velocity term controls the flatness of the near offset portion of a common image or common depth point gather and the η term controls the flatness of the far offset portion of the gather.

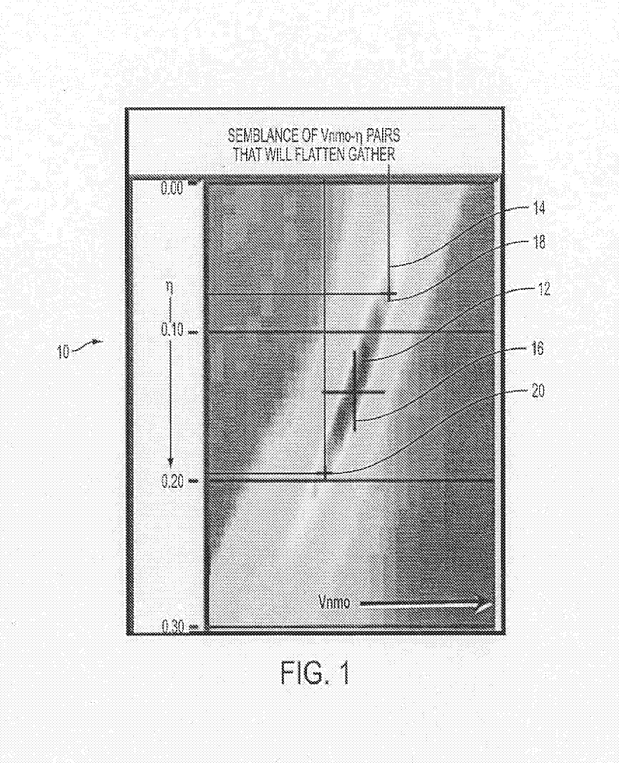

FIG. 1 illustrates analysis for a single reflection event 10 in vₙₘₒ/η space for a set of seismic data, shaded to indicate semblance of the seismic data for each particular model. The Figure shows a central medium grey region 12 surrounded by a lighter region 14 extending from the lower left towards the upper right of the figure. This central region represents that subset of vₙₘₒ and η (in which vₙₘₒ represents a normal moveout velocity and η is a parameter representing velocity anisotropy) pairs that will generally produce flat gathers and may be termed a “semblance banana” in reference to its extended and slightly curved shape. As can be readily seen, there is a tradeoff between velocity and anisotropy such that an increase in velocity accompanied by a decrease in anisotropy or vice versa produces motion along the diagonally extending region 12. As long as vₙₘₒ and η are changed in opposite senses, and are constrained by the extent of region 12, the resulting model may be expected to produce substantially flat gathers.

For models in which there is little or no well control, such as in an exploration setting, vₙₘₒ and η are generally determined only by the surface seismic data. A second anisotropy parameter, δ, is generally estimated from η (often 25-33% of η). Where well data is available, such as in an appraisal setting, or in a producing field where additional decisions regarding secondary production techniques are being made, the well data provide additional constraints on δ. In certain cases, depth error can be accounted for using a 1D model of wave propagation and making a tradeoff between velocity and δ. However, this may result in non-physical interpretations (non-physical velocities or anisotropic parameters) due to an unreasonable relationship between η and δ resulting from insufficient constraints on the anisotropic velocity. One explanation is that migration velocity and well velocities may not be properly calibrated because flat gathers and seismic to well tie are considered to the exclusion of other factors in evaluating the quality of the pre-stack depth migration (PSDM). The resulting models can produce geologically inconsistent structural realizations.

Illustrating this concept, within the central region, a baseline model is indicated by the cross at point 16. A second point 18 that lies near an upper right extent of the central region 12 represents a vₙₘₒ/η pair in which velocity is higher and anisotropy is lower for which a flat gather is expected (a fast model). A third point 20 that lies near a lower left extent of the central region 12 represents a vₙₘₒ/η pair in which velocity is lower and anisotropy is higher and for which a flat gather is likewise expected (a slow model). All three of the baseline, fast and slow models thus produce flat gathers, lie within a common semblance banana, and can be considered to be members of a family of equivalent models.

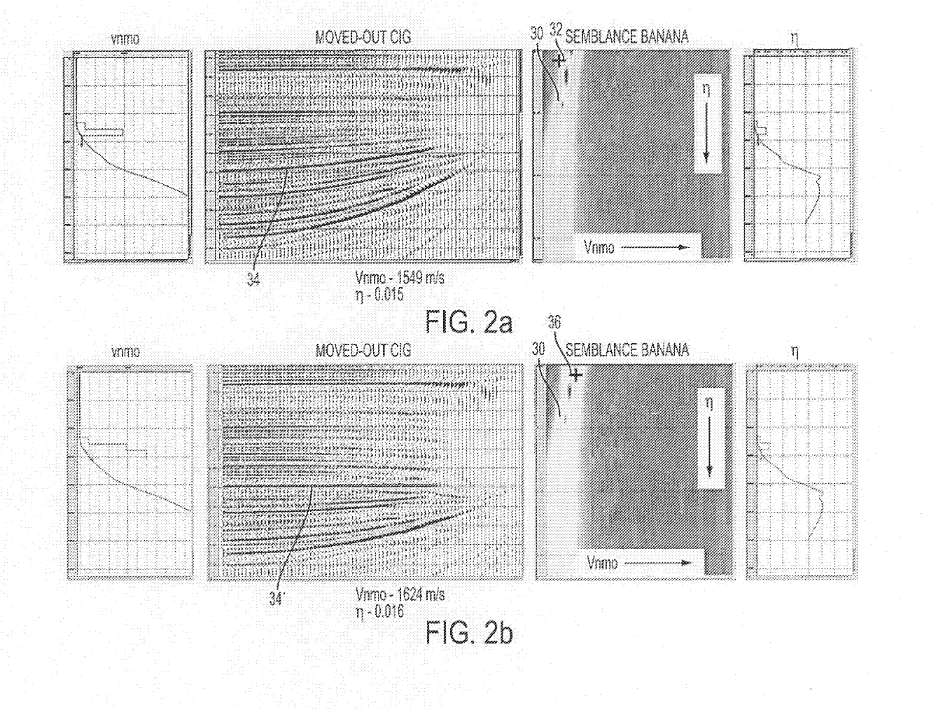

FIGS. 2a-d illustrate four different models generated using different assumptions regarding vₙₘₒ and η, selected from four different points around a common semblance banana 30. FIG. 2a illustrates an example for the point 32 at which vₙₘₒ=1549 m/s and η=0.015. The resulting moved out common image gather (CIG) shows some degree of curvature, especially along the strong reflection indicated at 34, indicating that this may not be a good anisotropy model. This result is to be expected from the fact that point 32 is slightly outside the portion of the semblance banana that indicates maximum semblance peak vₙₘₒ/η pair.

Moving to the right on the semblance banana to the point 36 (selected by an autopick function and representing a baseline model) produces the second model illustrated in FIG. 2b. In this Figure, vₙₘₒ=1624 m/s and η=0.016. In this case, the point 36 is within or near to the peak portion of the semblance banana and the CIG is flattened for the event at 34′ with respect to the CIG of FIG. 2a. That is, reflection 34′ shows better flatness than reflection 34 of FIG. 2a, and the FIG. 2b model therefore appears to be acceptable for this event.

FIG. 2c illustrates a slow model in which the point 38 is selected to be to the left of and lower than the position of point 36, but still within a common portion of the semblance banana (i.e., lower velocity, higher anisotropy, expected similar flatness). In this Figure, vₙₘₒ=1600 m/s and η=0.058. In contrast, FIG. 2d illustrates a fast model in which the point 40 is selected to be to the right of and higher than the position of point 36, and again within a common portion of the semblance banana (i.e., higher velocity, lower anisotropy, expected similar flatness). In this Figure, vₙₘₒ=1638 m/s and η=0.0. As expected, FIGS. 2c and 2d exhibit similar flatness and represent additional members of the family of solutions that contains the baseline solution.

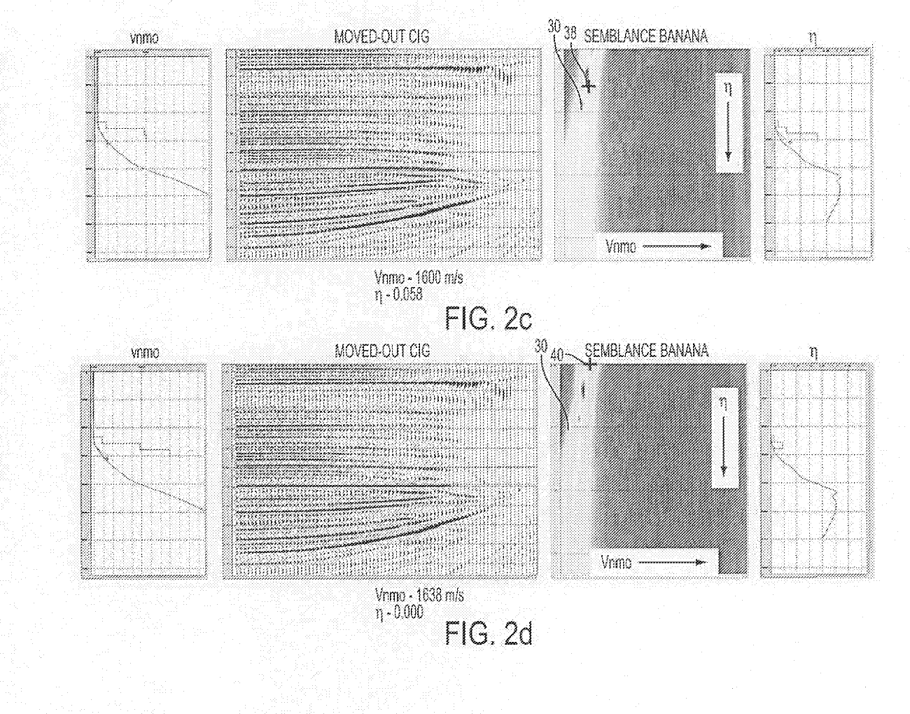

FIGS. 3a-c illustrate a family of three equivalent solutions for a set of seismic data that were produced using three different vₙₘₒ and η trends for slow, baseline and fast velocity assumptions, each of which produces a flat gather. In this set of Figures, FIG. 3a represents the slow model, FIG. 3b represents a baseline model and FIG. 3c represents the fast model. In each of FIGS. 3a-c, the vertical axis represents two-way time and the resulting gathers are substantially equally flat.

These models were further processed by conversion to the depth domain and the seismic data were further 3D prestack depth migrated in accordance with each model. The migrated gathers were then subjected to residual moveout analysis in order to completely flatten them. This additional step was required due to a number of factors including, approximations required in conversion between the two-way time domain and the depth domain, assumptions used in building end-member models that were used to parameterize the 3D PSDM algorithm.

The resulting processed models were then used to produce structural and depth information that may be used to inform prospect risk analysis for the reservoir. In particular, key horizons that were mapped from the baseline PSDM were flexed through a range using the fast and slow PSDMs as endpoints.

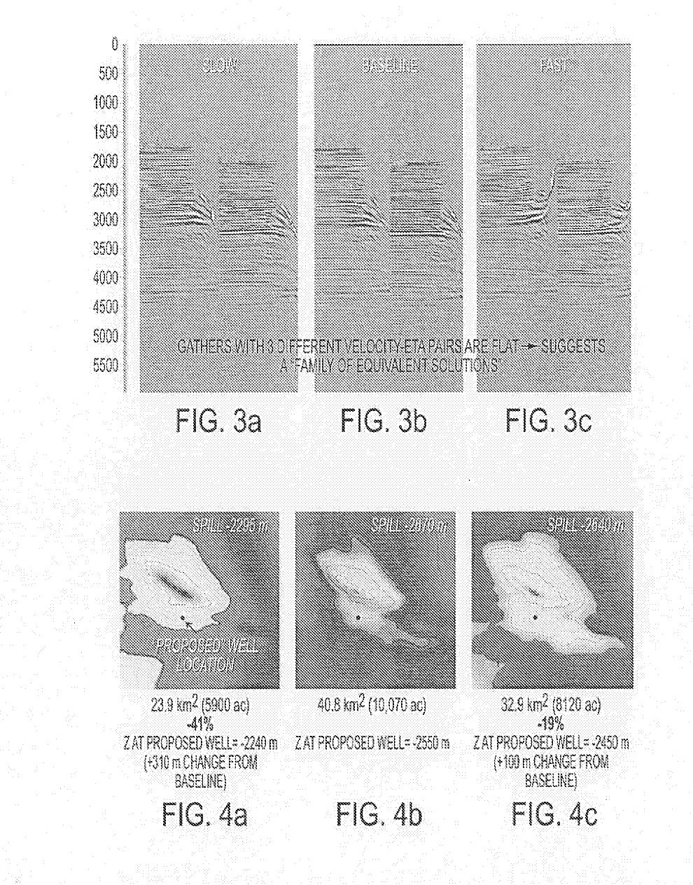

The results of this processing were used to produce a family of reservoir model maps as shown in FIGS. 4a-c. The reservoir model maps represent the top of an expected reservoir with the proposed location of a well to investigate this target indicated. In this regard, FIG. 4a corresponds to the slow model illustrated in FIG. 3a, FIG. 4b corresponds to the baseline model illustrated in FIG. 3b, and FIG. 4c corresponds to the fast model illustrated in FIG. 3c.

As may be seen from a comparison between FIGS. 4a and 4b, the slow model produces a reservoir size that is considerably smaller than the baseline case, with a target interval significantly shallower than baseline. Likewise, the fast model of FIG. 4c produces a reservoir size that is between that of the slow and baseline models. The target interval is also somewhat more shallow than the baseline target interval. While it might be expected that a faster model would result in generally increased depths, the target interval depends also on the shape of the structures being modeled. The spill point indicated on FIGS. 4a-c is the deepest closed contour surrounding the structural high. In this case, the slow model produces a shallower spill point that the baseline and fast models. The exact depth and shape of the spill point contour depends on the changes in velocity and structural model of the portion of the Earth above the target interval. Thus it is not always true that the slow model will produce the shallowest spill point contour.

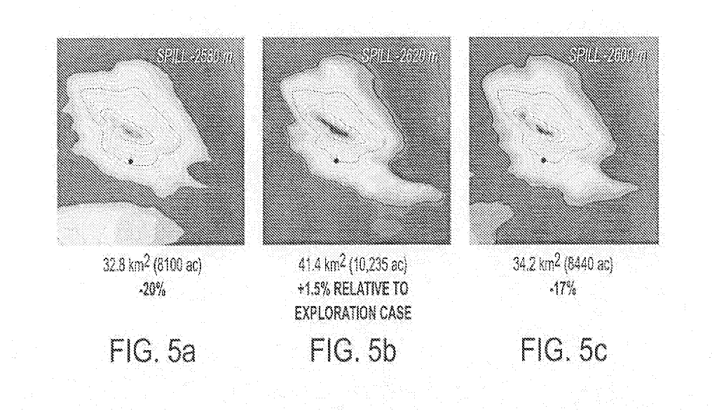

In the case of FIGS. 4a-c, no well tying was used to constrain the reservoir model, while FIGS. 5a-c represent the same models incorporating well tying for correction of δ. The well tying significantly improves the correlation in reservoir sizes between the slow and baseline models (FIGS. 5a and 5b). Likewise, it slightly improves the correlation in reservoir sizes between the baseline and fast models. Comparing the two cases, it could be said that the uncertainty has been reduced by the introduction of well tying data.

FIGS. 5a-c also illustrate the change in mapped reservoir area using the slow, baseline, and fast models. The total amount of structural uncertainty depends on the change in expected depth of the target interval and the change in the mapped reservoir area. The amount of well control and constraining the reservoir model using the well tying typically reduces the amount of structural uncertainty.

In general, where variation between realizations is small, it can be said that uncertainty is small and where variation is large, uncertainty is larger.

The features of the embodiments as illustrated in FIGS. 1, 2, and 3 illustrate the use of prestack depth migrated gathers for determining the various equivalent solutions. However, those experienced in the art will realize that a number of poststack depth migrations can be performed on seismic data to also produce a family of equivalent solutions. This family of equivalent solutions would be used to produce structural and depth information in order to assess structural uncertainty as previously illustrated in FIGS. 4 and 5.

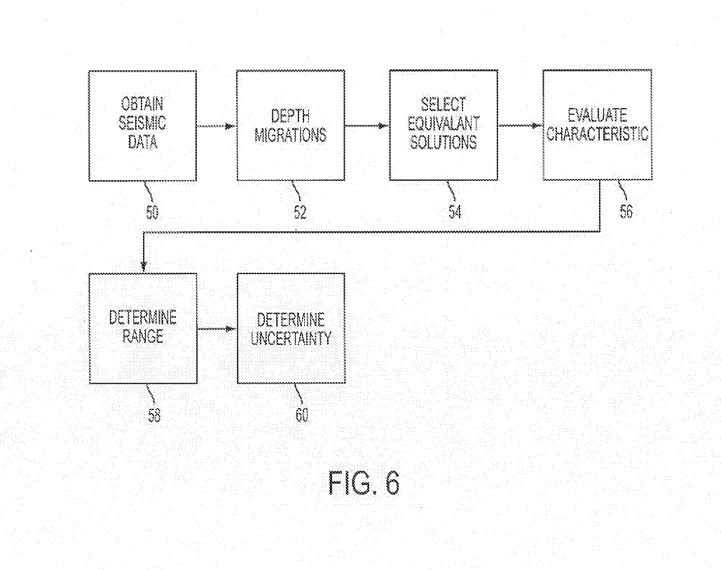

FIG. 6 is a flow chart illustrating a method in accordance with an embodiment of the invention. Seismic data including information representative of features of a subsurface region is obtained 50. This data may be acquired by any of a variety of seismic acquisition techniques, or may be existing seismic data stored locally or remotely from a computer system on which the method is executed. A plurality of depth migrations are performed 52 on the seismic data.

Each depth migration is based on a model using a respective set of parameters (e.g., vₙₘₒ, η, and/or δ) relating to a velocity field and anisotropy of the subsurface region. In particular, the models are designed to increase the likelihood that a majority of the depth migrations will produce members of the family of equivalent solutions. In this regard, estimates of acceptable ranges of velocity and anisotropic parameters are made based on surface seismic data. The acceptable ranges of velocity and anisotropic parameters include those that are physically realizable. These depth migrations may be done with either a prestack or poststack depth migration algorithm; although in most cases a prestack depth migration algorithm would be employed.

A family of equivalent solutions is selected 54 from the plurality of depth migrations and a characteristic of at least a portion of the subsurface region is evaluated 56 for each member of the family of equivalent solutions. Such a family may be defined, for example, by flatness of the gather, maximum semblance, or matching with other known data to define the velocity and anisotropy parameters.

Next, a range of values for the evaluated characteristic is determined 58 and based on the determined range, a degree of uncertainty of the seismic analysis is determined 60. In an embodiment, the evaluated characteristic may be a depth of a target interval, an area of a reservoir, a thickness of a pay zone or the like. The resulting range of depths of target intervals, for example, can be examined to determine the degree of uncertainty of the seismic analysis. As noted above, where, e.g., fast and slow models show good agreement with a baseline, then uncertainty can be said to be relatively low.

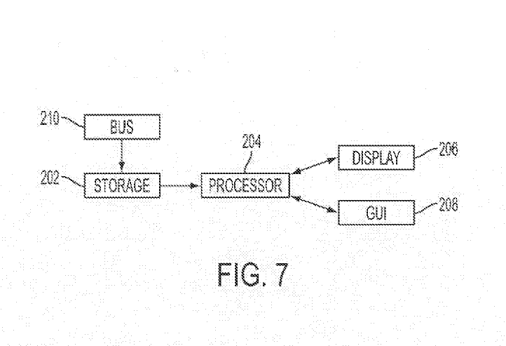

A system for performing the method is schematically illustrated in FIG. 7. A system includes a data storage device or memory 202. The stored data may be made available to a processor 204, such as a programmable general purpose computer. The processor 204 may include interface components such as a display 206 and a graphical user interface 208. The graphical user interface may be used both to display data and processed data products and to allow the user to select among options for implementing aspects of the method. Data may be transferred to the system via a bus 210 either directly from a data acquisition device, or from an intermediate storage or processing facility (not shown).

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A method of characterizing structural uncertainty in a seismic analysis of features in a subsurface region, comprising:
obtaining seismic data including information representative of the features;
performing a plurality of depth migrations on the seismic data, each depth migration being based on a model using a respective set of parameters relating to a velocity field and anisotropy of the subsurface region;
selecting a family of equivalent solutions from the plurality of depth migrations;
evaluating a characteristic of at least a portion of the subsurface region for each member of the family of equivalent solutions;
determining a range of values of the evaluated parameters; and
based on the determined range, determining a degree of uncertainty of the seismic analysis.

2. A method as in claim 1, wherein the respective sets of parameters comprise velocity and eta.

3. A method as in claim 2, wherein the respective sets of parameters further comprise delta.

4. A method as in claim 1, wherein the respective sets of parameters comprise velocity, epsilon and delta.

5. A method as in claim 1, wherein the selecting a family of equivalent solutions comprises selecting values of the parameters such that migrated gathers are flat.

6. A method as in claim 1, wherein models used in performing the plurality of depth migrations are selected using estimates of acceptable ranges of velocity and anisotropic parameters based on equivalent maximum coherence of the migrated surface seismic data.

7. A method as in claim 1, wherein the performing the depth migrations further comprises correlating the model to well data derived from wells that are present in the subsurface region.

8. A method as in claim 1, wherein the evaluating a characteristic of at least a portion of the subsurface region comprises determining a depth of a target interval at a proposed well location for each member of the family of equivalent solutions.

9. A method as in claim 8, wherein the determining a degree of uncertainty of the seismic analysis comprises determining a range of respective depths of a target interval at the proposed well locations.

10. A method as in claim 9, wherein the determined depth for one of the family members is selected as a baseline value and the other family members are compared to the baseline value.

11. A method as in claim 10, wherein one family member has a higher velocity parameter and lower anisotropy parameter than the family member selected as a baseline and one family member has a lower velocity parameter and higher anisotropy parameter than the family member selected as the baseline.

12. A method as in claim 1, wherein the evaluating a characteristic of at least a portion of the subsurface region comprises determining the closed structural area at the target interval encompassing a proposed well location for each member of the family of equivalent solutions.

13. A method as in claim 12, wherein the determining a degree of uncertainty of the seismic analysis comprises determining a range of structural closures of a target interval at the proposed well locations.

14. A method as in claim 13, wherein one of the family members is selected as a baseline value and the other family members are compared to the baseline value.

15. A method as in claim 14, wherein one family member has a higher velocity parameter and lower anisotropy parameter than the family member selected as a baseline and one family member has a lower velocity parameter and higher anisotropy parameter than the family member selected as the baseline.

16. A system configured and arranged to characterize structural uncertainty in a seismic analysis of features in a subsurface region, comprising:
a computer readable medium having computer readable seismic data stored thereon, the seismic data being representative of physical characteristics of the subsurface region; and
a processor, configured and arranged to:
obtain seismic data including information representative of the features;
perform a plurality of depth migrations on the seismic data, each depth migration being based on a model using a respective set of parameters relating to a velocity field and anisotropy of the subsurface region;
select a family of equivalent solutions from the plurality of depth migrations;
evaluate a characteristic of at least a portion of the subsurface region for each member of the family of equivalent solutions;
determine a range of values of the evaluated parameters; and
based on the determined range, determine a degree of uncertainty of the seismic analysis.

17. A system as in claim 16, wherein the processor is further configured to evaluate the characteristic of at least a portion of the subsurface region by determining a depth of a target interval at a proposed well location for each member of the family of equivalent solutions and to determine the degree of uncertainty of the seismic analysis by determining a range of respective depths of a target interval at the proposed well locations.

18. A system as in claim 17, further comprising a display for outputting a visual representation of the depths of the target interval at the proposed well locations.
